(19) United States
(12) Patent Application Publication
(10) Pub. No.: US 2025/0136025 A1
(43) Pub. Date: May 1, 2025

(54) GROMMET

(71) Applicant: LEONI Wiring Systems France, Montigny le Bretonneux (FR)

(72) Inventor: Jean-Marc Mathey, Garches (FR)

(21) Appl. No.: 18/690,803

(22) PCT Filed: Aug. 19, 2022
(86) PCT No.: PCT/EP2022/073189

§ 371 Date: Mar. 11, 2024

(30) Foreign Application Priority Data
Sep. 10, 2021 (EP) 21306246.6

(51) Int. Cl. B60R 16/02; F16L 5/10; H02G 3/22

(52) U.S. Cl. CPC B60R 16/0222; F16L 5/10; H02G 3/22

(57) ABSTRACT

A grommet with a sealing lip running around a longitudinal axis which extends in an axial direction. The sealing lip has a spring section configured such that the sealing lip is compressible which assists in developing a sealing effect for attaching the grommet to a mounting surface such as a wall.

The invention relates to a grommet, in particular a grommet, which is used for the sealed passage of a cable, line or conduit through a wall.

Grommets are used in a variety of ways and, irrespective of the specific application, are regularly used to seal two components against each other, closing or covering a gap that occurs between the two components. For example, in a vehicle a cable is routed from an engine compartment of the vehicle to a dashboard in an interior of the vehicle. The engine compartment is separated from the interior by means of a wall, and the cable is routed through this wall. For this purpose, the wall has a hole through which the cable is routed. A grommet is then inserted in the hole for sealing and said grommet comprises a lead-through into which the cable is inserted. In this way, the cable has no direct contact with the wall, but the grommet fills any space between the pipe and the wall and seals the two spaces on the two opposite sides of the wall against each other.

In general, but especially in the automotive sector, grommets have to meet particularly high requirements in terms of tightness against the passage of media, e.g. a fluid or a gas, and/or in terms of tightness against sound, as well as regularly high mechanical requirements and requirements for dimensioning the grommet due to installation space restrictions. These requirements may even lead to conflicting objectives in the design of the grommet.

Against this background, it is an objective of the present invention to specify an improved grommet. In particular, the grommet should seal as well as possible against the passage of media and/or sound, withstand mechanical loads as well as possible and also take up as little installation space as possible.

The task is solved according to the invention by a grommet with the features according to claim 1. Advantageous designs, further developments and variants are the subject of the dependent claims.

A core idea of the present invention is, in particular, to design a grommet with a special sealing lip in order to meet the requirements mentioned. The sealing lip, in particular its geometry and especially its cross-section, is designed in such a way that the sealing lip is compressible in a specific and particularly advantageous manner during assembly and, if necessary, also thereafter in the event of a mechanical load; namely in particular in such a way that the best possible sealing is still realized, but with a high degree of mechanical flexibility and in a particularly small installation space on a mounting surface.

The grommet described here has a sealing lip. The sealing lip is used for establishing sealing contact with a mounting surface, e.g. a side of a wall. The wall is, for example, a metal sheet. The sealing lip runs preferably annularly around a longitudinal axis which extends in an axial direction and at the same time perpendicular to a radial direction. According to the invention, the sealing lip has a spring section configured such that the sealing lip is compressible (i.e. can be compressed), in particular during assembly, i.e. mounting, of the grommet in or on the wall. Due to the spring section, the sealing lip is also referred to as a “spring sealing lip”. Because of the spring section, the sealing lip is not designed as a simple ramp, but has a more complex geometry.

The term “compressible” is understood to mean in particular “deformable by a pressing movement”, “crushable”, “collapsible” or “foldable”. The sealing lip is thus designed to compress or collapse itself, in particular in the event of a mechanical load in the axial direction and especially during assembly. Conversely, the sealing lip or at least the spring section is preferably elastic, so that when the load decreases, the sealing lip decompresses again, preferably automatically due to a spring action of the spring section. The sealing lip thus unfolds, expands or decompresses again.

The sealing lip is suitably cone-or bell-shaped, in particular to a first approximation. Preferably, the sealing lip is rotationally symmetrical with respect to the longitudinal axis. The grommet preferably has an inner body to which the sealing lip is connected, in particular in a radially outward direction, so that the sealing lip completely surrounds the inner body. In a suitable embodiment, the inner body serves to implement further functions of the grommet aside from sealing, e.g. for the sealing retention of a cable, line or conduit by means of a socket or spout as part of the inner body. The inner body may have any number of sockets or spouts, e.g. one or two or even more. However, the presence and the exact design of the inner body and whether it comprises any sockets or spouts are not important in the present case.

The grommet and in particular its sealing lip have a compressed, i.e. loaded, state and an uncompressed, i.e. unloaded, state. During assembly of the grommet, said grommet is regularly compressed and then preferably remains compressed even in the assembled state, so that the sealing lip is pressed permanently against the mounting surface and thus develops a sealing effect. The sealing lip is thus pretensioned, so to speak, by the spring section in the assembled state.

The spring section is in particular circumferential and then runs annularly around the longitudinal axis and, in particular, around the inner body. The spring section advantageously realizes a spring function, in particular in the axial direction, so that the sealing lip can be compressed at least in the axial direction. Accordingly, the spring section is designed in an overall spring-like manner and acts accordingly in the manner of a spring, especially as viewed in a cross section along the longitudinal axis. Said cross section along the longitudinal axis results from a cross-sectional plane which is spanned by the radial direction on the one hand and the axial direction on the other hand and in which the longitudinal axis lies. Insofar as only a cross section is referred to in the following, this cross section along the longitudinal axis is meant, unless the respective context indicates otherwise.

The invention is based in particular on the observation that a grommet can in principle be designed with a circumferential, ramp-shaped sealing lip which projects at a certain angle from an inner body of the grommet and bears sealingly against a mounting surface. When subjected to a mechanical load in the axial direction, especially during assembly, the sealing lip is splayed or spread further open (typically, the angle to the inner body is increased) and thus develops its sealing effect. The actual ramp-shaped geometry of the sealing lip is largely retained, the sealing lip is merely at a different angle. However, this greatly increases the diameter of the grommet and occupies corresponding installation space. The same applies to mechanical loads in the axial direction in the assembled state. In addition, such a grommet may not be able to absorb mechanical loads in the radial direction, i.e. perpendicular to the axial direction, sufficiently well and in such a case runs the risk of being lifted off the mounting surface and losing its sealing effect.

In contrast to this, the spring section described herein is advantageously configured such, that it allows compression of the sealing lip in such a way that no additional installation space is required on the mounting surface when the sealing lip is subjected to a mechanical load. Instead, the spring section is compressed, in particular in the axial direction, and thus absorbs the mechanical load without the sealing lip on the mounting surface being expanded, i.e. at least not appreciably expanded.

The grommet is, e.g., a dash panel grommet, for sealing when routing a cable, line or conduit from an engine compartment of a vehicle to a dash panel in an interior of said vehicle. However, the present invention is not restricted to such a use and the inventive concept may be used for any grommet.

In a suitable embodiment the grommet comprises a second sealing lip or counter sealing lip, said second sealing lip being located on the opposite side of the wall in the assembled (i.e. mounted) state such that the wall is sandwiched between the two sealing lips, thereby sealing against the wall from both sides. However, the presence and exact design of said second sealing lip are not relevant here. The second sealing lip may be a simple ramp-shaped sealing lip, but advantageously may also be configured as a spring sealing lip as described herein such that the grommet has two spring sealing lips. In one suitable embodiment the second sealing lip has a diameter larger than a diameter of the spring sealing lip, but the second sealing lip may also be dimensioned otherwise. Preferably, the second sealing lip is made from the same material as the spring sealing lip and both sealing lips are manufactured in one piece, i.e. monolithically.

Preferably, the sealing lip comprises an end section, which is attached to the spring section and which is in direct contact with the mounting surface after mounting. As already indicated, the grommet preferably has an inner body to which the sealing lip is connected in the radial direction outwardly. Further preferably, the spring section pivotally connects the inner body to the end section. In particular, the spring section acts as a link or hinge which is collapsed in the compressed state and is thus in particular bulged overall, preferably in a radially outward direction.

It is expedient that the sealing lip is rounded at the end, in particular, that the end section is rounded to facilitate contact with the mounting surface. Preferably, the end section is rounded such, that the sealing lip performs a rolling movement in the radial direction when mounted on the mounting surface, thereby deforming the spring section and compressing the sealing lip in the axial direction. In other words: upon mounting, the spring section is tilted and deflected in the radial direction and is then deformed (namely: compressed) as a result. As a result, the sealing lip is compressed in the axial direction. Alternatively or additionally and with the same effect, the sealing lip is rounded at the end in such a way that it slips over the mounting surface, i.e., performs a slipping movement, when subjected to a mechanical load, but advantageously without losing its sealing effect, since the end section continues to be pressed against the mounting surface by the preloaded spring section. Preferably, the rolling and/or slipping movement of the sealing lip, particularly its end section, is inwards in the radial direction, thereby reducing the installation space on the mounting surface.

In a suitable embodiment, the end section when viewed in cross-section has an outwards (i.e. towards the outside and the mounting surface) face, which is rounded or convex, and an inwards (i.e. towards the longitudinal axis and the inside of the grommet) face, which is flat or concave, but may also be convex or rounded. Upon mounting, the outwards face engages the mounting surface and upon compression rolls or slips across said mounting surface, such that the end section rolls and/or slips inwards and the inwards section is pivoted away from the mounting surface (similar to a shoveling motion).

In a suitable embodiment, the end section is turned inwards already in the uncompressed state and, in particular, turns further inwards upon compression. The term “turned inwards” is understood to mean that the end section is angled inwards with respect to the mounting surface, in particular such that when viewed in cross section the sealing lips radius along the end section is reduced towards the mounting surface. The end section is thus, so to say, pre-turned, which support an inwards movement of the end section.

The sealing lip is suitably rounded by having a spherical or drop-like shape at the end, viewed in cross-section along the longitudinal axis. Due to the rounded design, the end section rolls and/or slips over the mounting surface when a load is applied, so that the spring section is driven in the radial direction and thus bulges. In particular, the spring section is pulled apart.

A particularly preferred design is one in which the spring section is configured such that the sealing lip is widened (i.e. flared) in the axial direction in the uncompressed (i.e. unloaded) state, in particular like a cylinder, cone or funnel, and in the compressed (i.e. loaded) state is bulged in the radial direction, preferably outwards, and thus perpendicular to the axial direction. More specifically: the spring section, i.e. at least a part or segment of the spring section, assumes a curved shape upon loading. The spring section is preferably not bulged in the uncompressed state, but is preferably straight. Accordingly, the spring effect is realized precisely by the fact that the spring section bulges in the radial direction when loaded, thereby compressing the sealing lip in the axial direction. The bulging is preferably achieved either by forming a bulge from a straight configuration or by increasing an already present bulge, i.e. reduce a radius of curvature. This has the particular advantage that the sealing lip is configured such that the end section is not expanded during a load and thus does not require more installation space on the mounting surface. Instead, the spring section is arched so that the end section remains in an unchanged position on the mounting surface or moves inwards on the mounting surface, in particular towards the inner body. Thereby, the required installation space on the mounting surface is at least maintained or even reduced.

The terms “funnel-shaped” and “bell-shaped” generally mean an angled course and orientation of the sealing lip relative to the longitudinal axis, which results in the sealing lip having an overall funnel or bell shape as it passes around the longitudinal axis. In other words: the sealing lip runs at an angle relative to the longitudinal axis, said angle preferably is in the range from 2° to 30° in the uncompressed state. However, it is not meant that the sealing lip itself has a varying thickness to obtain a funnel or bell shape in cross-section. In fact, an embodiment is preferred in which the sealing lip has an inner wall which roughly points towards the longitudinal axis and an outer wall which roughly points in the opposite direction. Viewed in cross-section the inner wall preferably has a contour which follows a contour of the outer wall. The sealing lip has a thickness, said thickness being measured in the uncompressed state and in the radial direction. The general material strength (i.e. thickness measured perpendicular to the inner and/or outer wall) preferably does not substantially change when transitioning from the uncompressed to the compressed state or vice versa.

The spring section bulges in the radial direction either outward (and is then convex in the compressed state) or inward (and is then concave in the compressed state). Outward bulging (i.e. convex curvature) is preferred. In other words, in a suitable embodiment, the spring section is configured such that it bulges outwards when the sealing lip is mounted and thus generally when it is compressed. In particular, the spring section is configured to bulge outwards in such a way that a volume inside the grommet is maintained or increased. The volume is defined as the volume enclosed between the grommet and the mounting surface. This has the advantage that more volume is available inside the grommet than without a bulge or than with an inward bulge, as a result of which the grommet has better acoustic behavior, especially improved sealing against sound.

The curved shape is such that the inner wall and the outer wall of the spring section are curved in the same direction. In other words: the spring section bulges in one direction only and, hence, is so to say folded. This is in opposition to being squeezed, as would likely be the case for a predominantly soft material such as a foam or similar. Such squeezing does preferably not occur or is at least not the main mechanism responsible for the compression of the sealing lip. Instead, the spring section is so to say folded such that a bulge is created. Again, in other words: the inner wall and the outer wall of the spring section move into the same direction (either both radially outwards or both radially inwards) upon compression.

Preferably, the spring section is spring-like in that it has several (i.e. at least two) segments (also called joints) which connect to each other and thus make the spring section as a whole articulated or hinged. The spring section preferably has two, three or four segments, but other numbers are in principle also suitable, depending on the application. One of the segments is a first segment, which is connected to the inner body. Another segment is a second segment, which is connected to the first segment. The second segment is either a last segment for contact with the mounting surface or is also connected to a third segment or to an end section as already described, thereby linking the first segment with the third segment or end section. Additional segments may be added accordingly. In particular, two segments are connected to each other such, that they are pivotable against each other, such that the described bulging of the spring section is possible. Preferably, the bulging is mainly achieved by pivoting of the segments (i.e. relative movement of the segments against each other) and less by a deformation of each individual segment itself. In a suitable embodiment, at least two (preferably all) of the segments are connected pivotably to each other at a connection point (or fulcrum) such that at said connection point a bend, crease, step, shoulder, notch, groove or similar is formed, to facilitate the pivoting. Said bend, crease, notch, groove or similar preferably runs annularly around the longitudinal axis. In the alternative or in addition, at least two of the segments are connected pivotably to each other at the connection point such that at said connection point the spring section has a reduced thickness when measured in the radial direction, to facilitate pivoting. In other words: in a suitable embodiment, the thickness of the spring section is reduced at the connection point as compared to the thickness otherwise at the segments. Such reduced thickness is e.g. realized with a tapered section at or around the connection point, e.g. a groove or notch, or by a bend, crease, step or shoulder which is configured such, that the contour on the inner wall is displaced or offset in the axial direction and relative to the contour of the outer wall, preferably such that a staggered arrangement is achieved, wherein an inner part of the bend, crease, step or shoulder on the inner wall is shifted in the axial direction and relative to an outer part of said bend, crease, step or shoulder on the outer wall.

In an advantageous embodiment, the spring section is step-shaped when viewed in cross-section along the longitudinal axis, at least in the uncompressed state. In the uncompressed state, the steps preferably point in the same direction, if several steps are present. In the compressed state, the segments preferably collapse into a meandering shape or generally a zigzag course, so that the segments then point alternately in opposite directions or in the alternative bulge together inwardly or outwardly, as already described above.

In an advantageous embodiment, the spring section is meander-shaped when viewed in cross-section along the longitudinal axis, i.e. has a meander shape, at least in the uncompressed state. Here, in particular, each segment of the spring section forms a single bend. The bends are then lined up with alternating curvature directions. In the compressed state, the segments preferably collapse in such a way that the meander shape is stretched in the radial direction and compressed in the axial direction. A respective bend thus deforms either inward or outward in the radial direction, such that the meander-shape in generally preserved. Alternatively, as already described in connection with the steps, all of the bends bulge either inwardly or outwardly, so that the meander shape is lost and broken up, so to speak.

In a particularly practical embodiment, the sealing lip comprises an end section which is configured as a mass section. The mass section is preferably configured such, that the spring section is deformed while the mass section is not deformed, but merely displaced as a result of deforming the spring section. To achieve this according to a suitable embodiment, the mass section, when measured in the radial direction, is thicker than the spring section. The sealing lip is thus thickened at the end, the mass section thus having a greater thickness than the spring section, the thickness being measured in cross section and in the radial direction, i.e. perpendicular to the longitudinal axis. Preferably, the thickness is at least increased on the outer wall of the sealing lip, more preferably by a convex contour, such that a rounded end section is formed as described above while at the same time increasing the thickness at the end section to obtain a mass section. In particular, the term “mass” is understood as referring to the increased thickness and/or an increased volume of the mass section when compared to the spring section. In a suitable embodiment, this also leads to the mass section being heavier (i.e., having a larger mass) than the spring section, although this is not necessarily the case. For example, in another suitable embodiment the mass section is made from a material which is less dense than the material of the spring section, thereby realizing a mass section which is thicker and preferably more voluminous than the spring section but not necessarily heavier. Preferably, the end of the spring section is that end, which is the farthest away from the longitudinal axis at least in the uncompressed state. If no mass section in attached to the end of the spring section, then said end is preferably a free end.

The mass section is a particularly preferred embodiment of the end section of the sealing lip as already described above. The mass section has a wider thickness than the spring section. Advantageously the mass section is spherical or drop-shaped in cross-section along the longitudinal axis, so that the sealing lip as a whole is rounded at the end.

Particularly when configured as a mass section, the end section forms with the spring section a mass-spring system with advantageous mechanical properties.

Since the mass section is thicker than the spring section, the spring section is primarily deformed and specifically compressed when a load is applied, while the mass section is not significantly deformed, so that the sealing effect of the grommet is maintained. In accordance with these different functions of the two sections (mass section and spring section) in the deformation of the sealing lip, the spring section is also referred to as the “first deformation zone” and the mass section as the “second deformation zone”. Even though the mass section is not necessarily deformed itself, it significantly influences the deformation of the spring section. In particular, this design favors axial deformation of the sealing lip over radial deformation and even advantageously limits radial deformation and thus radial protrusion, so that installation space is saved. The sealing lip thus does not expand predominantly in the radial direction, but is compressed in the axial direction and the spring section is folded together in the axial direction, so to speak, which limits the expansion of the sealing lip in the radial direction.

The mass section suitably has a thickness in the range of 4 mm to 5 mm. The thickness preferably being measured in cross section and in the radial direction, i.e. perpendicular to the longitudinal axis.

The spring section suitably has a thickness in the range of 1.5 mm to 3 mm. The thickness preferably being measured in cross section and in the radial direction, i.e. perpendicular to the longitudinal axis.

In one useful embodiment, the grommet is configured to be mounted in or on a wall and has at least one socket or spout, particularly as part of the inner body, for passing a cable, line or conduit through the wall. Alternatively, a socket or spout may also be used for embedding any other functional component into the grommet. Any socket or spout of the grommet is not necessarily concentric with the sealing lip, but may also be non-centric and run parallel to and at some radial distance from the longitudinal axis.

Preferably, the sealing lip, the sealing lip and inner body or the entire grommet is made from an elastic material. Suitably, the elastic material is a plastic, preferably EPDM, such that at least the sealing lip is made of EPDM (i.e. ethylene-propylenediene rubber). Preferably, the inner body is also made of EPDM and, in addition, is expediently made in one piece, i.e. monolithically with the sealing lip. Overall, the grommet is preferably made of a rubber and/or a thermoplastic, at least predominantly. Some embodiments of the grommet may include one or more inserts (see below), which are not necessarily made from an elastic material, but rather preferably are made from a rigid material, e.g. PP, PE, ABS, a metal or other material.

Also advantageous is an embodiment in which the grommet has an insert (first insert) for fastening the grommet to the mounting surface, i.e. in or on the wall, in such a way that the spring section remains compressed after assembly and is thus pretensioned. For this purpose, the insert preferably comprises a number of fastening elements. In a particularly suitable embodiment, the fastening elements are configured as clips for clipping the grommet onto or into the wall. The insert is suitably made of a more rigid material than the sealing lip and possibly also the inner body. A respective clip has a head which forms an undercut, whereby the clip as a whole is formed as a barb. When the grommet is mounted in or on a wall, the insert is pushed through the hole from one side of the wall in such a way that the heads are pushed through and then spring back outwards in a radial direction on the other side and engage, thereby hooking the grommet in the wall. The sealing lip itself is not pushed through the hole in the wall, but is merely pressed against one side and thereby compressed. In the assembled state, the sealing lip on the one hand and the head or heads on the other hand are then arranged on opposite sides of the wall, so that the wall is clamped accordingly. Due to the spring action of the now compressed spring section, the grommet is mounted particularly firmly in the wall.

In an advantageous embodiment, the sealing lip comprises a number of bulges (different from the bulging of the spring section), to accommodate a corresponding number of fastening elements of the insert as mentioned above. Aside from the bulges, the sealing lip preferably is rotationally symmetrical with respect to the longitudinal axis. The number of bulges is e.g. 3, but other numbers, such as 2 or 4 or even more are in principle also suitable. The bulges are preferably distributed evenly around the sealing lip. Each bulge provides a small volume on the inside of the grommet for accommodating a fastening element, e.g. a clip as mentioned above or part of such, preferably at least in the uncompressed state. In a suitable embodiment, the fastening elements are released from the bulges upon mounting and engage the wall on the opposite side of the sealing lip, such that in the compressed state the fastening element no longer resides in the bulge.

In an advantageous embodiment, said insert is rigid, in particular compared to the sealing lip, and serves as mechanical stabilization of the grommet. Such function may also be realized with a corresponding insert independently from above-described fastening function.

In a suitable embodiment, the grommet has an insert (second insert) to restrict the air volume inside the grommet and thereby improve its acoustic behavior. Such an insert is preferably plate shaped and extends perpendicular to the longitudinal axis. Preferably, the insert surrounds any socket or spout of the inner body. Said insert is preferably separate to, but may also be identical with the insert for fastening and/or mechanical stability mentioned before.

One advantage in particular is that the special geometry of the sealing lip primarily causes axial deformation of the sealing lip, in particular essentially independently of the direction of a mechanical load. At the same time, the special geometry of the sealing lip also limits its radial deformation. This advantageously minimizes the expansion or spreading of the grommet on the mounting surface when absorbing a mechanical load, e.g. due to movement of a cable, line or conduit which is held by the grommet. Excessive expansion of the grommet on the mounting surface in a radially outward direction is prevented when the grommet is pressed against the mounting surface under a mechanical load. Depending on the mechanical load, the spring section is advantageously compressed like a spring (this may also include the described bulging in the radial direction) or decompressed, thereby making it possible to absorb particularly strong translations of the grommet while still maintaining optimum sealing. The sealing effect between the sealing lip and the mounting surface is thus maintained despite strict boundary conditions.

A further advantage is in particular that particularly small dimensions, especially thicknesses, are possible for the grommet and especially for the sealing lip, e.g. as already described above. This saves material.

In particular, a further advantage that, especially in the embodiment with a mass section, is that a contact area between the sealing lip and the mounting surface is increased, resulting in a better seal. Since the mass section is specifically thicker or more voluminous than the spring section, the mass section also has a corresponding mass, e.g. 10 g-15 g, and then, depending on the orientation of the grommet in the mounted state relative to gravity, further contributes to the seal, namely by being supported by gravity, provided that the sealing lip is placed on the mounting surface from above. However, in the case of a grommet between the engine compartment and the interior of a vehicle, the longitudinal direction typically extends parallel to the roadway and perpendicular to gravity.

A further advantage is in particular the minimization of the installation space required by the grommet, as already mentioned above on several occasions. Vehicle manufacturers regularly specify a limited area on the mounting surface, e.g. a surface of a metal sheet, beyond which the grommet should not protrude. The special geometry of the sealing lip described here ensures a particularly high level of sealing in a particularly small installation space.

Another advantage is that the direct contact of the sealing lip, especially the end section, with the mounting surface results in a particularly high level of tightness against media, especially water, and sound.

Another advantage is in particular that the grommet is easier to assemble, as lower forces are required during assembly, especially compared to a grommet with only a ramp-shaped sealing lip. This then leads to less exhaustion of workers assembling the grommet.

The task is also solved in particular by using the described grommet for sealing against a mounting surface. Furthermore, the task is also solved in particular by a method for manufacturing a grommet as described and by a method for mounting a grommet as described. The explanations regarding the grommet also apply accordingly to the use and the two methods.

Examples of embodiments of the invention are explained in more detail below with reference to a drawing. Said drawing comprises several figures, schematically showing as follows:

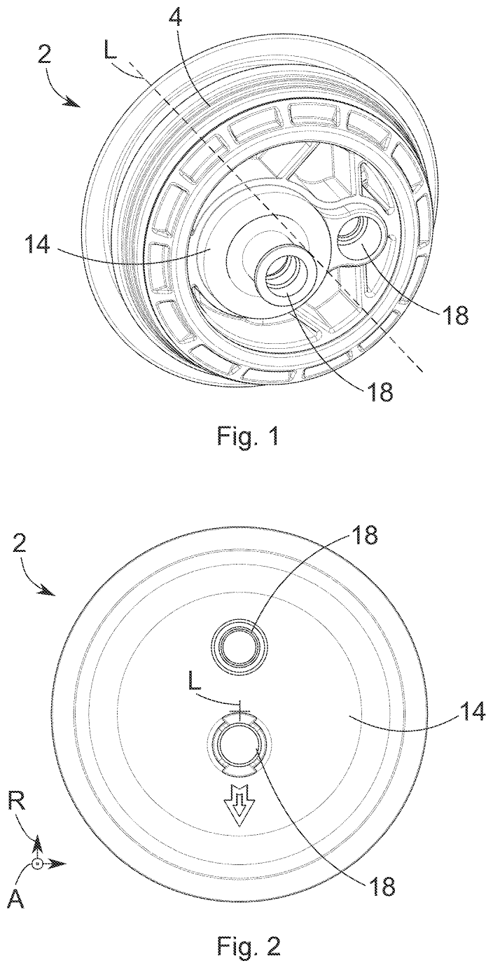

FIG. 1 a grommet in a perspective view from behind,

FIG. 2 the grommet from FIG. 1 in a front view,

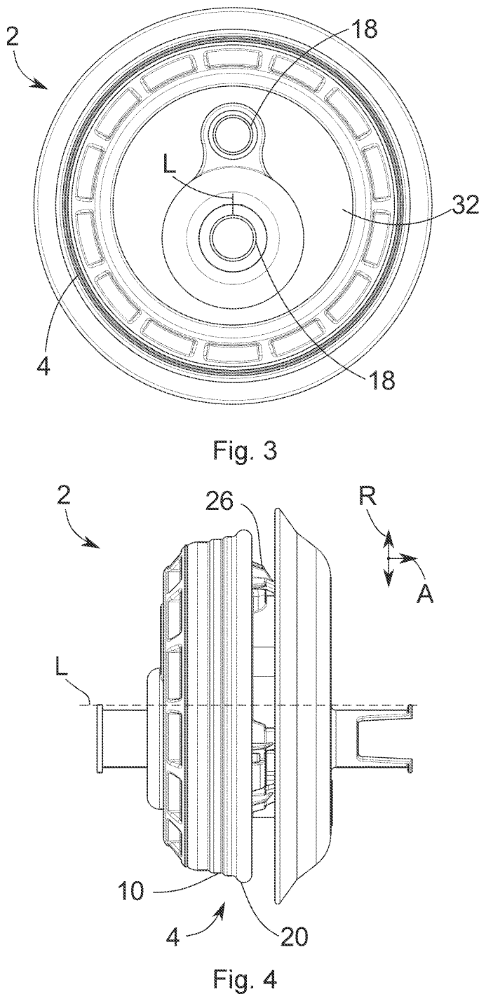

FIG. 3 the grommet from FIG. 1 in a rear-side view,

FIG. 4 the grommet from FIG. 1 in a side view,

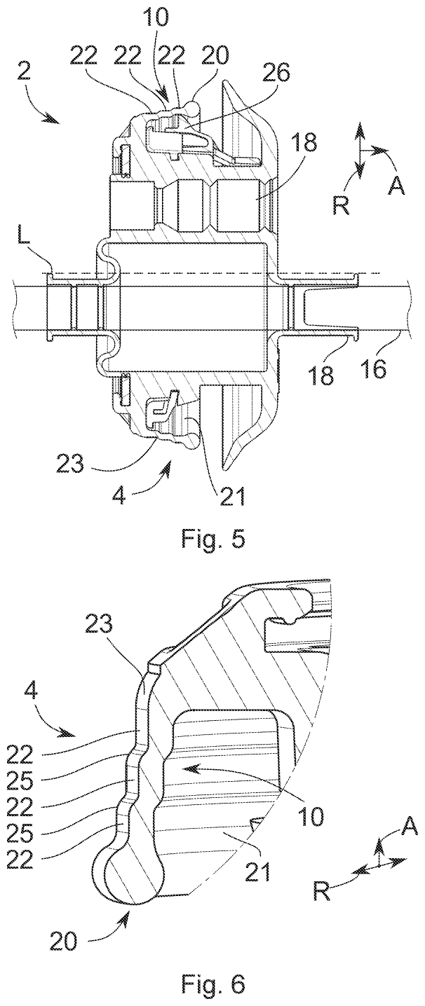

FIG. 5 the grommet from FIG. 1 in a cross-sectional view,

FIG. 6 a sealing lip of the grommet from FIG. 1 in a cross-sectional, perspective view,

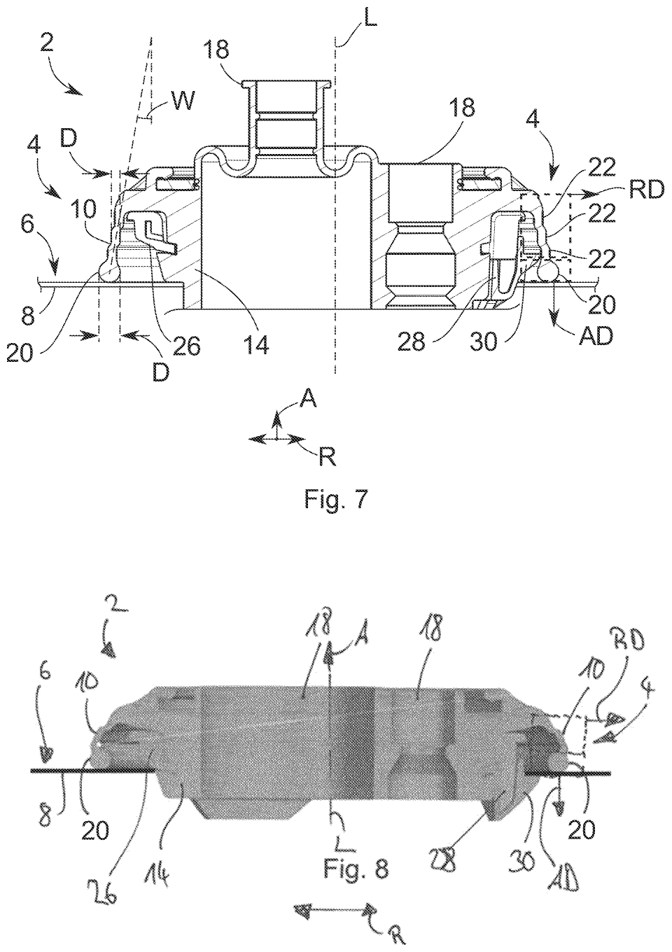

FIG. 7 a partial, cross-sectional view of the grommet from FIG. 1 in an uncompressed state,

FIG. 8 a partial, cross-sectional view of the grommet from FIG. 1 in a compressed state,

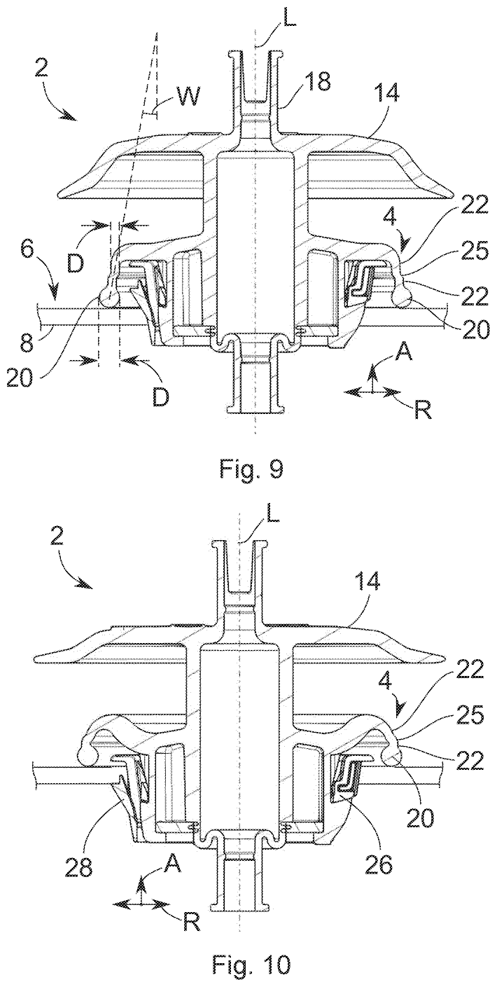

FIG. 9 an alternative embodiment of the grommet from FIG. 1 in a cross-sectional view and in an uncompressed state,

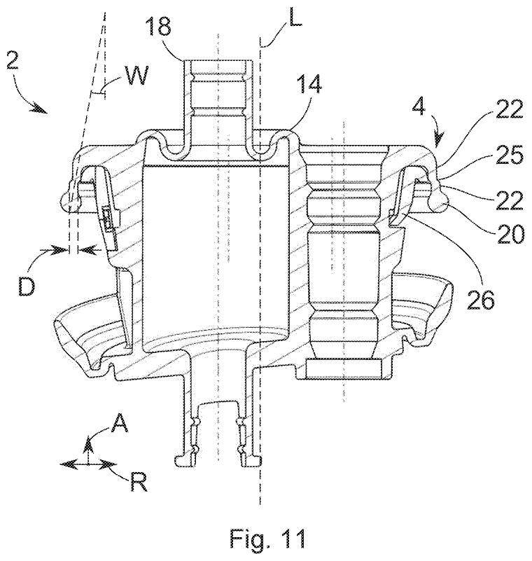

FIG. 10 the grommet from FIG. 9 in a compressed state,

FIG. 11 another alternative embodiment of the grommet from FIG. 1 in a cross-sectional view and in an uncompressed state,

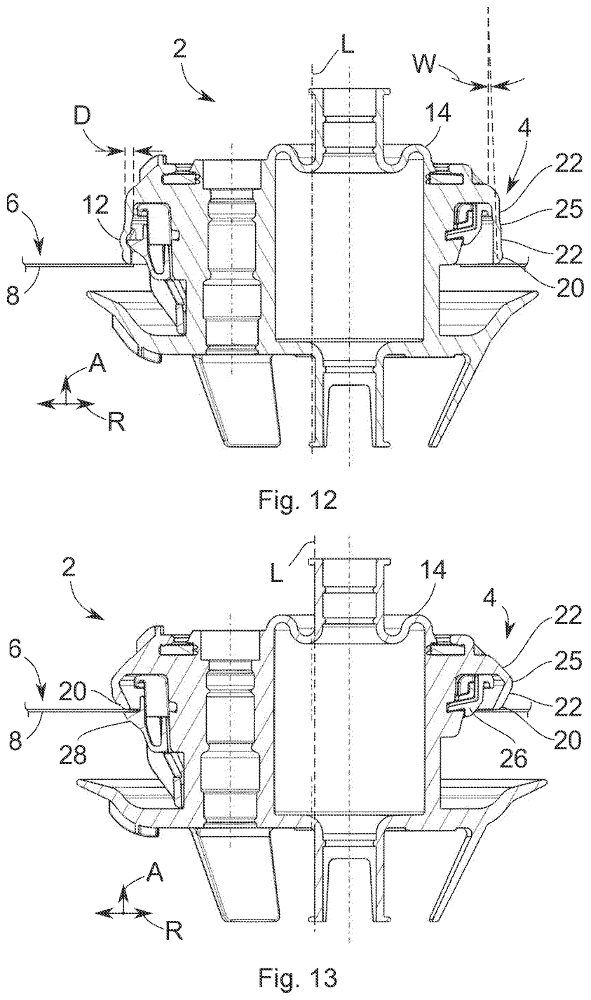

FIG. 12 another alternative embodiment of the grommet from FIG. 1 in a cross-sectional view and in an uncompressed state,

FIG. 13 the grommet from FIG. 12 in a compressed state.

The figures show several possible embodiments of a grommet 2 with a special sealing lip 4. The sealing lip 4 is designed in such a way that it is compressible in a specific manner during assembly and, if necessary, also thereafter in the event of a mechanical load. By virtue of the special sealing lip 4, the grommet 2 ensures a high degree of tightness while still allowing flexibility and while also requiring minimal installation space.

The grommet's 2 sealing lip 4 is used for establishing sealing contact with a mounting surface 6, e.g. a side of a wall 8, e.g. a metal sheet. In the present examples, the sealing lip 4 runs annularly around a longitudinal axis L which extends in an axial direction A and at the same time perpendicular to a radial direction R. The sealing lip 4 has a spring section 10 configured such that the sealing lip 4 is compressible, in particular during assembly, i.e. mounting, of the grommet 2 in or on the wall 8. Due to the spring section 10, the sealing lip 4 is also referred to as a “spring sealing lip”. Because of the spring section 10, the sealing lip 4 is not designed as a simple ramp, but has a more complex geometry, e.g. as shown in FIGS. 5 to 13, especially in the close-up view of FIG. 6.

The sealing lip 4 shown here is cone-or bell-shaped to a first approximation, as can be seen in the side view of FIG. 4, the cross-sections of FIGS. 5 and 7 to 13 and again in the detailed view of FIG. 6. In the embodiments shown here, the sealing lip 4 is rotationally symmetrical with respect to the longitudinal axis L, wherein in FIGS. 12 and 13, this symmetry is only broken by a number of bulges 12. The grommet 2 optionally has an inner body 14 to which the sealing lip 4 is connected in a radially outward direction, so that the sealing lip 4 completely surrounds the inner body 14. In the present embodiments, the inner body 14 serves to implement further functions of the grommet 2 aside from sealing, e.g. for the sealing retention of a cable, line or conduit 16 (see e.g. FIG. 5) by means of a socket or spout 18 as part of the inner body 14. The inner body 14 may have any number of sockets or spouts 18, in FIGS. 1, 2, 3 and 5 two sockets or spouts 18 are visible.

The grommet 2 and more specifically its sealing lip 4 have a compressed, i.e. loaded, state, shown in FIGS. 8, 10 and 13, and an uncompressed, i.e. unloaded, state, shown in FIGS. 7, 9, 11 and 12. During assembly of the grommet 2, said grommet 2 is regularly compressed and then remains compressed even in the assembled state, so that the sealing lip 4 is pressed permanently against the mounting surface 6 and thus develops a sealing effect. The sealing lip 4 is thus pretensioned, so to speak, by the spring section 10 in the assembled state as, e.g., shown in FIGS. 8, 10 and 13. Compression of the sealing lip 4 for the grommet 2 in FIG. 11 is essentially the same as in FIG. 10.

A possible embodiment for the spring section 10 is in detail shown in the cross-sectional view of FIG. 6, but its special geometry and variations thereof is also clearly visible in the remaining figures. The spring section 10 is circumferential and runs annularly around the longitudinal axis L and also around the inner body 14. The spring section 10 realizes a spring function, in particular in the axial direction A, so that the sealing lip 4 can be compressed at least in the axial direction A. Accordingly, the spring section 10 is designed in an overall spring-like manner and acts accordingly in the manner of a spring, especially as viewed in a cross section along the longitudinal axis L as shown in FIGS. 5 to 13. Said cross section along the longitudinal axis L results from a cross-sectional plane which is spanned by the radial direction R on the one hand and the axial direction A on the other hand and in which the longitudinal axis L lies.

The special geometry of the sealing lip 4 is based on the observation that a grommet 2 can in principle be designed with a circumferential, ramp-shaped sealing lip which projects at a certain angle from the inner body 14 of the grommet 2 and bears sealingly against the mounting surface 6. When subjected to a mechanical load in the axial direction A, especially during assembly, the ramp-shaped sealing lip is splayed or spread further open while the actual ramp-shaped geometry of the sealing lip is largely retained. However, this greatly increases the diameter of the grommet 2 and occupies corresponding installation space. The same applies to mechanical loads in the axial direction A in the assembled state. In addition, such a grommet 2 may not be able to absorb mechanical loads in the radial direction R sufficiently well and in such a case runs the risk of being lifted off the mounting surface 6 and losing its sealing effect.

In contrast to this, the spring section 10 described here advantageously allows compression of the sealing lip 4 in such a way that no additional installation space is required on the mounting surface 6 when the sealing lip 4 is subjected to a mechanical load. Instead, the spring section 10 is compressed, in particular in the axial direction A, and thus absorbs the mechanical load without the sealing lip 4 on the mounting surface 6 being expanded, at least not appreciably, as is evident when comparing FIGS. 7 and 8 to each other as well as FIGS. 9 and 10, 12 and 13.

In the embodiments shown here, the sealing lip 4 comprises an end section 20, which is attached to the spring section 10 and which is in direct contact with the mounting surface 6 after mounting. The sealing lip 4 is connected to the inner body 14 in the radial direction R outwardly and the spring section 10 pivotally connects the inner body 14 to the end section 20. Thus, the spring section 10 acts as a link or hinge which is collapsed in the compressed state and is bulged overall in a radially outward direction.

In all the embodiments shown here, the sealing lip 4 is rounded at the end, more specifically, the end section 20 is rounded to facilitate contact with the mounting surface 6. The end section 20 is rounded such, that the sealing lip 4 performs a rolling and/or slipping movement in the radial direction R when mounted on the mounting surface 6, thereby deforming the spring section 10 and compressing the sealing lip 4 in the axial direction A. The rolling and/or slipping movement of the sealing lip 4, specifically of its end section 20, is inwards in the radial direction R, thereby reducing the installation space on the mounting surface 6.

The end section 20 when viewed in cross-section generally has an outwards (i.e. towards the outside and the mounting surface) face, which is rounded or convex as seen in all the figures, and an inwards (i.e. towards the longitudinal axis L and the inside of the grommet 2) face, which is flat as in FIGS. 12 and 13 or concave (not shown), but may also be rounded or convex as in the other figures. Upon mounting, the outwards face engages the mounting surface 6 and upon compression rolls and/or slips across said mounting surface 6, such that the end section 20 rolls and/or slips inwards and the inwards section is pivoted away from the mounting surface 6 (similar to a shoveling motion). In the embodiments shown in FIGS. 5 to 11, the sealing lip 4 is rounded by having a spherical or drop-like shape at the end, when viewed in cross-section.

In the present case, the spring section 10 is configured such that the sealing lip 4 is widened (i.e. flared) in the axial direction A in the uncompressed (i.e. unloaded) state, like a cone or funnel, and in the compressed (i.e. loaded) state is bulged in the radial direction R. More specifically: the spring section 10 assumes a curved shape upon loading, see FIGS. 8, 10 and 13. The spring section 10 shown here is not bulged in the uncompressed state, as is evident from FIGS. 7, 9, 11 and 12. Accordingly, the spring effect is realized precisely by the fact that the spring section 10 bulges in the radial direction R when loaded, thereby compressing the sealing lip 4 in the axial direction A. An end section 20 of the sealing lip 4, which is in direct contact with the mounting surface 6 after mounting, is not expanded during a load and thus does not require more installation space on the mounting surface 6. Instead, the spring section 10 is arched so that the end section 20 remains in a substantially unchanged position on the mounting surface 6. In the uncompressed state, the sealing lip 4 runs at an angle W relative to the longitudinal axis L, said angle W being in the range from 2° to 30° for the embodiments presented here.

The sealing lip 4 of the present embodiment has an inner wall 21 which roughly points towards the longitudinal axis L and an outer wall 23 which roughly points in the opposite direction. Viewed in cross-section the inner wall 21 has a contour which follows a contour of the outer wall 23. As can be seen in the figures, the sealing lip 4 has a thickness D which is measured in the uncompressed state and in the radial direction R.

The curved shape is such that the inner wall 21 and the outer wall 23 of the spring section 10 are curved in the same direction. In other words: the spring section 10 bulges in one direction only and, hence, is so to say folded. This is in opposition to being squeezed, which does not occur here or is at least not the main mechanism responsible for the compression of the sealing lip 4. Instead, the spring section 10 is so to say folded such that a bulge is created. Again, in other words: the inner wall 21 and the outer wall 23 of the spring section 10 move into the same direction (either both radially outwards or both radially inwards) upon compression.

The spring section 10 bulges in the radial direction R either outward as in the embodiments shown here (and is then convex in the compressed state) or inward as in an alternative not explicitly shown here (and is then concave in the compressed state). In other words, the spring section 10 is configured such that it bulges outward when the sealing lip 4 is mounted and thus generally when it is compressed. This also leads to more volume being available inside the grommet 2 than without a bulge or than with an inward bulge, for an improved acoustic behavior.

The spring section 10 shown here is spring-like in that it has several segments 22 (also called joints) which connect to each other and thus make the spring section 10 as a whole articulated or hinged. The spring section 10 preferably has two (FIGS. 9 to 13), three (as in FIGS. 5 to 8) or four segments 22 (not shown), but other numbers are also suitable depending on the application. One of the segments 22 is a first segment 22, which is connected to the inner body 14. Another segment 22 is a second segment 22, which is connected to the first segment 22. The second segment 22 is either a last segment 22 for contact with the mounting surface 6 or is also connected to a third segment 22 or to an end section 20 as already described, thereby linking the first segment 22 with the third segment 22 or end section 20. Additional segments 22 may be added accordingly. Two segments 22 are connected to each other such, that they are pivotable against each other, such that the described bulging of the spring section 10 is possible. The bulging is mainly achieved by pivoting of the segments 22 and less by a deformation of each individual segment 22 itself.

In the embodiments shown here, several of the segments 22 are connected pivotably to each other at a connection point 25 such that at said connection point 25 a bend, crease, step, shoulder, notch, groove or similar is formed, to facilitate the pivoting. In all of the embodiments shown here, steps or shoulders are formed at each connection point 25. In the alternative or in addition (as shown here), the spring 10 section at the connection points 25 has a reduced thickness D, to facilitate pivoting, i.e. the thickness D is reduced at the connection point 25 as compared to the thickness D otherwise at the segments 22. In the embodiments shown here, such reduced thickness D is realized by a step or shoulder which is configured such, that the contour on the inner wall 21 is displaced or offset in the axial direction A and relative to the contour of the outer wall 23, such that a staggered arrangement is achieved, wherein an inner part of step or shoulder on the inner wall 21 is shifted in the axial direction A and relative to an outer part of said step or shoulder on the outer wall 23 (however, such displacement or offsetting in the axial direction A is not strictly necessary to achieve a reduced thickness in the radial direction R).

In the exemplary embodiments of FIGS. 7 to 13, the spring section 10 is step-shaped when viewed in cross-section along the longitudinal axis L, at least in the uncompressed state. In the compressed state shown in FIGS. 8, 10 and 13, the segments 22 bulge together outwardly, as already described above.

In the embodiments shown here, the end section 20 is configured as a mass section, which is thicker than the spring section 10 when measured in the radial direction R. The sealing lip 4 is thus thickened at the end, the mass section thus having a greater thickness D than the spring section 10, the thickness D being measured in cross section and in the radial direction R. The mass section forms with the spring section 10 a mass-spring system with advantageous mechanical properties.

Since the mass section is thicker than the spring section 10, the spring section 10 is primarily deformed and specifically compressed when a load is applied, while the mass section is not significantly deformed, so that the sealing effect of the grommet 2 is maintained. In accordance with these different functions of the two sections in the deformation of the sealing lip 4, the spring section 10 is also referred to as the “first deformation zone” and the mass section as the “second deformation zone”. Both deformation zones are indicated in FIGS. 7 and 8 by a respective rectangular box and their respective function, namely relating to axial deformation AD and radial deformation RD, is indicated by a corresponding arrow. Even though the mass section is not necessarily deformed itself, it significantly influences the deformation of the spring section 10. In particular, this design favors axial deformation AD of the sealing lip 4 over radial deformation RD and limits said radial deformation RD and thus radial protrusion. The sealing lip 4 thus does not expand predominantly in the radial direction R, but is compressed in the axial direction A and the spring section 10 is folded together in the axial direction A, so to speak, which limits the expansion of the sealing lip 4 in the radial direction R.

As already indicated, the grommets 2 shown here have an inner body 14 to which the sealing lip 4 is connected in the radial direction R outwardly. The spring section 10 pivotally connects the inner body 14 to the mass section and acts as a link or hinge which is collapsed in the compressed state.

The sealing lip 4 is made of, e.g., EPDM (i.e. ethylene-propylene-diene rubber). Optionally, the inner body 14 is also made of EPDM. In addition (and as shown here) the inner body 14 and the sealing lip 4 are made in one piece, i.e. monolithically.

The grommets 2 shown here also have an insert 26 (first insert) for fastening the respective grommet 2 in or on the wall 8 in such a way that the spring section 10 remains compressed after assembly and is thus pretensioned. For this purpose, the insert 26 has a number of clips 28 for clipping the grommet 2 onto or into a wall 8. The insert 26 is made of a more rigid material than the sealing lip 4. A respective clip 28 has a head 30 which forms an undercut, whereby the clip 28 as a whole is formed as a barb. When the grommet 2 is mounted in or on the wall 8, the insert 26 is pushed through the hole from one side of the wall 8 in such a way that the heads 30 are pushed through and then spring back outwards in the radial direction R on the other side and engage, thereby hooking the grommet 2 in the wall 8. The sealing lip 4 itself is not pushed through the hole in the wall 8, but is merely pressed against one side and thereby compressed. In the assembled state, the sealing lip 4 on the one hand and the heads 30 on the other hand are then arranged on opposite sides of the wall 8, so that the wall 8 is clamped accordingly. Due to the spring action of the now compressed spring section 10, the grommet 2 is mounted particularly firmly in the wall.

In the embodiment of FIGS. 12 and 13, the sealing lip 4 comprises a number of bulges 12, to accommodate a corresponding number of fastening elements, here the clips 28, at least in the uncompressed state as shown in FIG. 12. In FIG. 13, the fastening elements are released from the bulges 12 upon mounting and engage the wall 8 on the opposite side of the sealing lip 4.

Here, said Insert 26 is rigid compared to the sealing lip 4 and also serves as mechanical stabilization of the grommet 2. Such function, however, may also be realized with a corresponding insert independently from above-described fastening function.

Furthermore, the grommets 2 shown here optionally have another insert 32 (second insert) to restrict the air volume inside the grommet 2 and thereby improve its acoustic behavior. Such an insert 32 is visible in FIG. 3. The insert 32 is plate shaped and extends perpendicular to the longitudinal axis L and surrounds any socket or spout 18 of the inner body 14.

The inserts 26, 32 are each purely optional and their respective design may be entirely different from the one shown here.

### LIST OF REFERENCE SIGNS

2 grommet
4 sealing lip
6 mounting surface
8 wall
10 spring section
12 bulge
14 inner body
16 cable, line or conduit
18 socket or spout
20 end section (in particular mass section)
21 inner wall
22 segment
23 outer wall
25 connection point
26 insert (first insert)
28 clip
30 head
32 insert (second insert)
A axial direction
AD axial deformation
D thickness
L longitudinal axis
R radial direction
RD radial deformation
W Angle

1-21. (canceled)

22. A grommet, comprising:
a sealing lip running around a longitudinal axis extending in an axial direction, said sealing lip having a spring section configured such that said sealing lip is compressible.

23. The grommet according to claim 22, wherein said spring section realizes a spring function, so that said sealing lip can be compressed at least in the axial direction.

24. The grommet according to claim 22, wherein said spring section is configured such, that it allows compression of said sealing lip such that no additional installation space is required on a mounting surface when said sealing lip is subjected to a mechanical load, instead, said spring section is compressed and thus absorbs a mechanical load without said sealing lip on the mounting surface being expanded.

25. The grommet according to claim 22, further comprising an inner body to which said sealing lip is connected in a radial direction outwardly, wherein said sealing lip has an end section, which is attached to said spring section and which is in direct contact with a mounting surface after mounting, wherein said spring section pivotally connects said inner body to said end section.

26. The grommet according to claim 25, wherein said sealing lip is configured such that said end section is not expanded during a load and thus does not require more installation space on the mounting surface, instead, said spring section is arched so that said end section remains in an unchanged position on the mounting surface or moves inwards on the mounting surface.

27. The grommet according to claim 25, wherein said end section is rounded such that it performs a rolling and/or slipping movement in the radial direction when mounted on the mounting surface, thereby deforming said spring section and compressing said sealing lip in the axial direction.

28. The grommet according to claim 22, wherein said spring section is configured such that said sealing lip is widened in the axial direction in an uncompressed state and is bulged outwards in a radial direction in a compressed state.

29. The grommet according to claim 28, wherein said spring section is configured to bulge outwards such that a volume inside the grommet is maintained or increased, wherein the volume is defined as a volume enclosed between the grommet and a mounting surface.

30. The grommet according to claim 22, wherein said sealing lip runs at an angle relative to the longitudinal axis, said angle being in a range from 2° to 30° in an uncompressed state.

31. The grommet according to claim 22, wherein said spring section is spring-shaped in that it has several segments which connect to each other and thus make said spring section as a whole articulated or hinged.

32. The grommet according to claim 31, wherein:
at least two of said segments are connected pivotably to each other at a connection point such that at said connection point a bend, crease, step, shoulder, notch, or groove is formed, to facilitate pivoting; and/or
at least two of said segments are connected pivotably to each other at said connection point such that at said connection point said spring section has a reduced thickness when measured in a radial direction, to facilitate pivoting.

33. The grommet according to claim 22, wherein said spring section is step-shaped or meander-shaped when viewed in cross-section along the longitudinal axis.

34. The grommet according to claim 22, wherein said sealing lip has an end section, which is configured as a mass section and which, measured in a radial direction, is thicker than said spring section.

35. The grommet according to claim 34, wherein said mass section is spherical or drop-shaped in cross-section along the longitudinal axis.

36. The grommet according to claim 34, wherein said mass section has a thickness in a range of 4 mm to 5 mm.

37. The grommet according to claim 22, wherein said spring section has a thickness in a range of 1.5 mm to 3 mm.

38. The grommet according to claim 22, wherein the grommet is configured to be mounted in a wall and has at least one socket or spout for passing a cable, line or conduit through the wall.

39. The grommet according to claim 22, where said sealing lip is made of ethylene-propylenediene rubber (EPDM).

40. The grommet according to claim 22, wherein said sealing lip is rotationally symmetrical with respect to the longitudinal axis.

41. The grommet according to claim 22, further comprising an insert for fastening in or on a wall such that said spring section remains compressed after assembly and is thus pretensioned.

42. The grommet according to claim 41, wherein:
said insert has fastening elements; and
said sealing lip has a plurality of bulges, to accommodate a corresponding number of said fastening elements of said insert.
